(19) United States
(12) Patent Application Publication
(10) Pub. No.: US 2017/0141944 A1
(43) Pub. Date: May 18, 2017

(54) VERIFIER FOR NETWORK FUNCTION VIRTUALIZATION RESOURCE ALLOCATION

(71) Applicant: ELECTRONICS AND TELECOMMUNICATIONS RESEARCH INSTITUTE, Daejeon (KR)

(72) Inventors: Seung-Ik LEE, Daejeon (KR); Yun-Chul CHOI, Daejeon (KR); Myung-Ki SHIN, Seoul (KR); Jong-Hwa YI, Daejeon (KR); Ji-Hyun LEE, Daejeon (KR)

(73) Assignee: ELECTRONICS AND TELECOMMUNICATIONS RESEARCH INSTITUTE, Daejeon (KR)

(21) Appl. No.: 15/339,133

(22) Filed: Oct. 31, 2016

(30) Foreign Application Priority Data
Nov. 13, 2015 (KR) 10-2015-0159923

(51) Int. Cl. H04L 12/24; H04L 29/06; H04L 29/08

(52) U.S. Cl. CPC H04L 41/04; H04L 67/10; H04L 67/42

(57) ABSTRACT

Disclosed herein is a method for managing network resources required in a Network Function Virtualization (NFV) environment. A verifier for Network Function Virtualization (NFV) resource allocation includes a network information reception unit for receiving information about network services from Operations Support Systems (OSS) or Business Support Systems (BSS) in an NFV environment, a combination information generation unit for generating combination information made when Virtualized Network Functions (VNFs) required by each network service are allocated to physical or virtual network resources, based on the received network service information, and a verification unit for verifying whether the combination information is applicable to available network resources in the NFV environment. Accordingly, a network service provider and a network administrator may detect problems related to resource availability in advance, thus more securely deriving the design of network services and the planning to secure network resources.

### CROSS REFERENCE TO RELATED APPLICATION

This application claims the benefit of Korean Patent Application No. 10-2015-0159923, filed Nov. 13, 2015, which is hereby incorporated by reference in its entirety into this application.

### BACKGROUND OF THE INVENTION

1. Technical Field

The present invention relates to a method for managing network resources required in a Network Function Virtualization (NFV) environment.

2. Description of the Related Art

As technology for supporting the opening and virtualization of a network to construct future-oriented networks and service infrastructure, Network Function Virtualization (NFV) technology has been introduced. This is intended to implement a single network service by virtually installing, combining and instantiating required network functions to handle traffic of the network service. By means of NFV technology, a network service may be configured in a timely manner by virtualizing network functions, and may be actively controlled depending on the situation.

In NFV, one or more Virtualized Network Functions (VNFs) and methods for installing and connecting them so as to configure a network service are logically defined in a network service descriptor (NSD). An NFV platform automatically allocates physical/virtual network resources for VNFs required for the execution of each network service based on the network service descriptor. More specifically, the NFV platform (especially the orchestrator of Management and Orchestration (MANO)) automatically performs the allocation and management of resources depending on various factors, including 1) network service requirements and policies, 2) the maximum performance and capacity of network resources, 3) resource management policies of network operators, and 4) real-time variation in the state of network services and network resources.

However, since the allocation and management of resources are instantaneously performed by an automated system without a human being's intervention, it is very difficult to recognize or determine the state of resource allocation in advance.

Further, the total amount of resources required for the execution of network services may be recognized in advance based on a network service descriptor, but several problems remain, as described below. More specifically, 1) it is practically impossible to specify in advance the time of instantiation and termination of each service, 2) even if the maximum performance and capacity of resources are specified in advance, resource capacity may change due to faults in resources or delay in the provision of resources, and 3) individual network services are not organically designed so that they use the shared network resources to obtain their own maximum performance individually, and thus it is impossible in practice to establish in advance a resource allocation plan suitable for the requirements and policies of all network services.

### SUMMARY OF THE INVENTION

Accordingly, the present invention has been made keeping in mind the above problems occurring in the prior art, and an object of the present invention is to provide a verifier for NFV resource allocation, which may verify in advance whether network resources requirements and network resource operational policies, described in multiple network service descriptors, are applicable to currently available network resources, and may notify a network service provider and a network administrator of the state of failure in a network service, which may occur due to a lack of network resources, and of the detailed cause of the failure, thus improving the stability of the operation of an NFV environment.

In accordance with an aspect of the present invention to accomplish the above object, there is provided a verifier for Network Function Virtualization (NFV) resource allocation, including a network information reception unit for receiving information about network services from Operations Support Systems (OSS) or Business Support Systems (BSS) in an NFV environment; a combination information generation unit for generating combination information made when Virtualized Network Functions (VNFs) required by each network service are allocated to physical or virtual network resources, based on the received network service information; and a verification unit for verifying whether the combination information is applicable to available network resources in the NFV environment.

The network information reception unit may further receive Network service policy (NS policy), network service descriptor (NSD) and NFV Infrastructure policy (NFVI policy) from the OSS or the BSS, and information about an allocation state of the network resources from an NFV platform, which allocates physical or virtual network resources depending on VNFs, and the verification unit may verify whether the combination information is applicable using the NS policy, NSD and NFVI policy and the allocation state information.

The combination information generation unit may be configured to generate virtual combination information on a condition that the VNFs are operated in at least one Virtual Machine (VM), and the VM is deployed on physical resources determined by the NFV platform depending either on whether physical network resources are allocated or on an operational policy.

The network service information may include information about resource requirements of each network service; information about an operational policy of resources used by VNFs constituting the network service; and information about an operational policy of resources in the NFV environment.

The information about resource requirements may include quantifiable information about a Central Processing Unit (CPU), memory, and networking performance and information about an affinity between VMs in which VNFs are operated.

The verification unit may determine whether, for physical resources on which at least one VM is deployed, a total amount of the physical resources required by the VM exceeds a maximum capacity of the physical resources, thus verifying whether the combination information is applicable.

The verification unit may determine whether, for respective physical resources on which corresponding VMs are deployed, the physical resources have an affinity therebetween, thus verifying whether the combination information is applicable.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram of a typical NFV environment;

FIG. 2 is a conceptual diagram of a network environment to which a verifier for NFV resource allocation according to an embodiment of the present invention is applied;

FIG. 3 is a block diagram showing in detail the verifier for NFV resource allocation according to an embodiment of the present invention; and

FIG. 4 is a flowchart showing a verification method performed by the verifier for NFV resource allocation according to an embodiment of the present invention.

### DESCRIPTION OF THE PREFERRED EMBODIMENTS

The following description merely illustrates the principle of the present invention. Accordingly, although not clearly described or shown in the present specification, those skilled in the art may realize the principle of the invention and devise various devices falling within the concept and scope of the invention. Further, it should be understood that all conditional terms and embodiments listed in the present specification are merely intended to obviously describe the concept of the invention in principle, and are not limited by the embodiments and states especially listed in this way.

The above other objects, features and advantages of the present invention will be more clearly understood from the following detailed description taken in conjunction with the accompanying drawings, and those skilled in the art to which the present invention pertains may easily practice the technical spirit of the present invention.

In the following description of the present invention, detailed descriptions of known functions and configurations which are deemed to make the gist of the present invention obscure will be omitted. Hereinafter, preferred embodiments of the present invention will be described in detail with reference to the attached drawings.

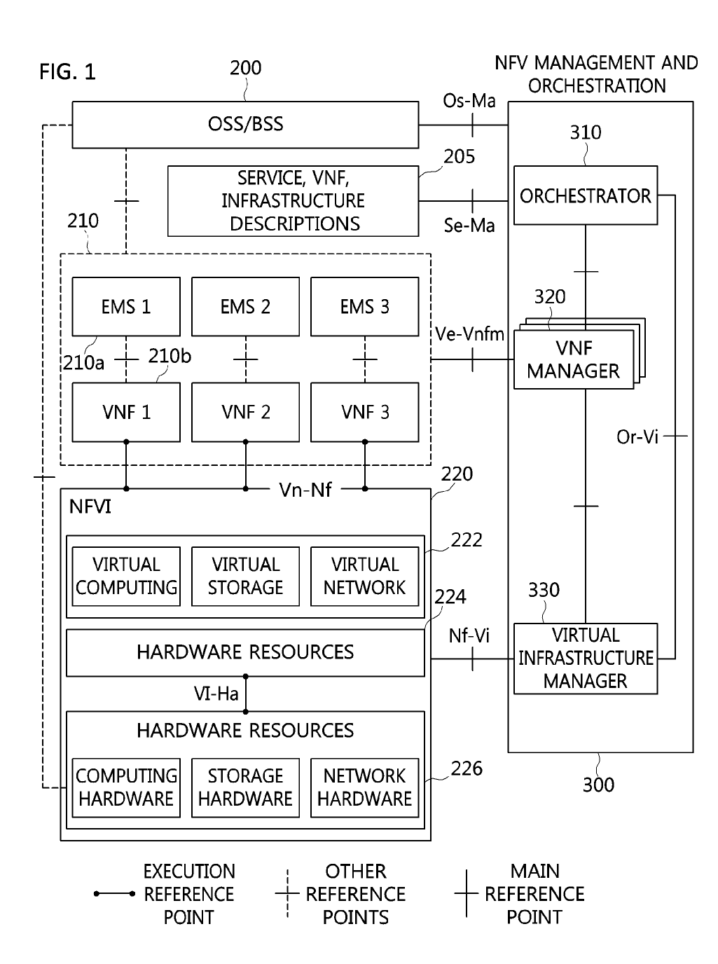

FIG. 1 is a conceptual diagram of a typical Network Function Virtualization (NFV) environment.

NFV technology is based on the structure of FIG. 1, and chiefly includes Virtualized Network Functions (VNFs) 210, NFV Infrastructure (NFVI) 220 and an NFV Management and Orchestration (MANO) block 300.

The VNFs 210 are software module blocks, which provide actual network functions and which are managed by virtualized resources. The NFVI 220 is a network resource block that provides multiple separate physical hardware components for supporting the computing, storage, and networking of VNFs by virtualizing the physical hardware components into a single infrastructure block. The MANO block 300 is a module block for handling the overall management, operation, control, etc. of the VNFs and the NFVI.

In order to provide a series of network services based on the NFV structure, 1) a network service descriptor in which one or more VNFs 210 constituting the corresponding service are defined and arranged and in which resource allocation/management requirements and operation details for installing and executing (instantiating) the VNFs are defined should be described, and 2) the descriptor should be delivered to and registered in the MANO block 300 through Operations Support Systems (OSS) or Business Support Systems (BSS) 200. Thereafter, when a request for the instantiation of the corresponding network service is received, an NFV platform (especially the orchestrator 310 of the MANO block) establishes a service so that incoming traffic may be processed by deploying the VNFs 210, defined in the network service descriptor, at suitable locations in the NFVI 220 and by connecting the VNFs 210 depending on given requirements and operation details. The NFV platform (especially the orchestrator 310 of the MANO block) continues to perform monitoring and control so that, even during the operation of the network service, designated requirements and policies may be obeyed against a dynamic change in a service state, such as the performance of the service, the state of network resources, and the traffic state.

That is, in typical NFV, one or more VNFs and methods for installing and connecting the VNFs are logically defined in a network service descriptor so as to configure a network service, and the NFV platform automatically allocates physical/virtual network resources 222, 224, and 226 for VNFs, required for the execution of each network service based on the network service descriptor. More specifically, the NFV platform (especially the orchestrator 310 of the MANO block) automatically performs the allocation and management of resources depending on various factors, including 1) network service requirements and policies, 2) the maximum performance and capacity of network resources, 3) resource management policies of network operators, and 4) real-time variation in the state of network services and network resources.

Since such allocation and management are instantaneously performed by an automated system without a human being's intervention, it is very difficult to recognize or determine the state of resource allocation in advance. The total amount of resources required for the execution of network services may be recognized in advance based on a network service descriptor, but the following problems remain. That is, 1) it is impossible in practice to specify in advance the time of instantiation and termination of each service, 2) even if the maximum performance and capacity of resources are specified in advance, the resource capacity may change due to faults in resources or delay in the provision of resources, and 3) individual network services are not organically designed, and shared resources are maximally used to individually obtain maximum performance, and thus it is not only practically impossible, but also contrary to the original aim of NFV, to establish in advance a resource allocation plan suitable for the requirements and policies of all network services.

In this situation, it is difficult for a network service provider to determine whether network resources are available based on the designed network service descriptor, thus increasing the uncertainty of service provision. That is, the network service provider designs a network service based on resource requirements and operational policies that may exhibit maximum performance only for the corresponding network service. However, in the state in which the state of currently available network resources or the requirements of other network services cannot be known, it is difficult to predict the performance of the corresponding network service.

It is also difficult for a network operator to determine in advance the capacity of network resources required to simultaneously install and execute (instantiate) network services having different resource requirements and operational policies. If available network resources become insufficient during the provision of a specific service, it is impossible to install and instantiate the required network service, thus making it difficult to consistently provide the service.

For example, it is assumed that the network service descriptor of Network Service A (NS A) is given in the following Table 1.

```
TABLE 1
Network service descriptor of NS_A
  component VNF: VNF_A, VNF_B
  resource requirements:
    VNF_A: 3 CPU cores
    VNF_B: 2 CPU cores
  resource operational policy:
    Affinity rule between VNF_A and VNF_B (i.e. VNF_A and VNF_B
should be deployed on the same physical resource)
```

Based on this network service descriptor, when the instance of VNF_A is deployed on physical node A (PN_A), and thereafter it is desired to deploy VNF_B on the same PN_A based on the affinity policy, it is impossible to meet the resource requirements of VNF_B unless 2 CPU cores are available in PN_A, thus causing a service failure.

Of course, if network resources that are much more than the total required resources are provided (in the case of so-called over-provisioning), such a concern may be reduced. However, such over-provisioning may not be a suitable solution because 1) the inefficiency of resource operation and management expenses are increased, and 2) resource operational policies for network services (e.g. an affinity rule or the like) are not taken into consideration in combination with other factors.

Therefore, a verifier for NFV resource allocation (hereinafter also referred to as “NFV resource allocation verifier”) according to the present invention is intended to verify the availability of resources and an operational policy in advance before a network service is installed, detect possible problems, and analyze the detected problems.

By way of this intention, a network service provider may predict the state of resource allocation in advance before an actual service is initiated, and may then adjust resource requirements and an operational policy in conformity with the expected performance of the network service. Further, a network operator may estimate the total network capacity that is required in order to simultaneously execute (instantiate) multiple established network services, and the efficiency of the network services.

For this, the present invention aggregates network resource requirements and resource operational policies (network service policies), described in multiple network service descriptors, as network service information in NFV, and deploys and configures, in advance, required VNFs on the NFVI that is the currently available network resource, thus verifying the possibility of securing resources in advance. The state of failure in resource allocation, which is predicted via such verification, and the cause of the failure are provided to a network service provider (or a network service designer) and a network operator (or a network administrator), thus providing assistance in the design of network services and the planning of network resource management.

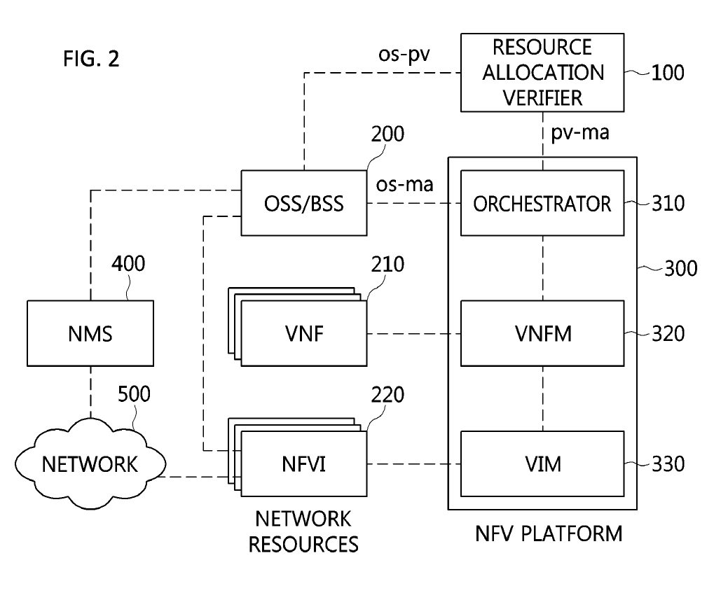

Hereinafter, the NFV resource allocation verifier according to the present invention will be described in detail with reference to FIG. 2.

FIG. 2 is a diagram showing an NFV environment to which the NFV resource allocation verifier according to the present invention is applied.

FIG. 2 illustrates an NFV resource allocation verifier 100 and interfaces corresponding thereto, and os-pv and pv-ma denote structures additionally proposed in the present invention.

In addition, structures and interfaces of an NFV platform 300, network resources (NFVI) 220, a Network Management System (NMS) 400, and a network 500 comply with those previously defined in NFV standards.

Although the structures and functions of the NMS 400 and the network 500 are not defined in NFV standards, the NMS and the network have structures that are easily realized in an actual implementation stage, wherein the NMS functions to extract and establish the network-related information of NFVI.

In NFV, a network service provider defines a Network Service Descriptor (NSD), and a network operator performs a procedure for requesting the NFV platform 300 to register and install the network service descriptor (via the os-ma) through OSS/BSS 200.

In this case, the NFV resource allocation verifier 100 according to the present invention performs the following procedure before the above-described procedure, for requesting the NFV platform 300 to register and install the network service descriptor, in order to verify a network service.

As network service information, 1) a network service descriptor and 2) a network service operational policy (hereinafter also referred to as a “1” or an “NS policy”) are received. As network resource information, 1) a network resource operational policy (hereinafter also referred to as a “Network Function Virtualization Infrastructure policy” or an “NFVI policy”) and 2) a network resource state are received. Based on the received information, the instances of deployment and allocation of resources are virtually combined with each other, and thus the instance in which failure in the allocation of resources is predicted and the cause of the failure are determined and reported.

Here, the NFV resource allocation verifier 100 according to the present invention exchanges verification information and the results of verification with the OSS/BSS 200 through an interface os-pv between the NFV resource allocation verifier 100 and the OSS/BSS 200, as shown in FIG. 2, without interfering with the unique interface or operating procedure of the NFV platform 300.

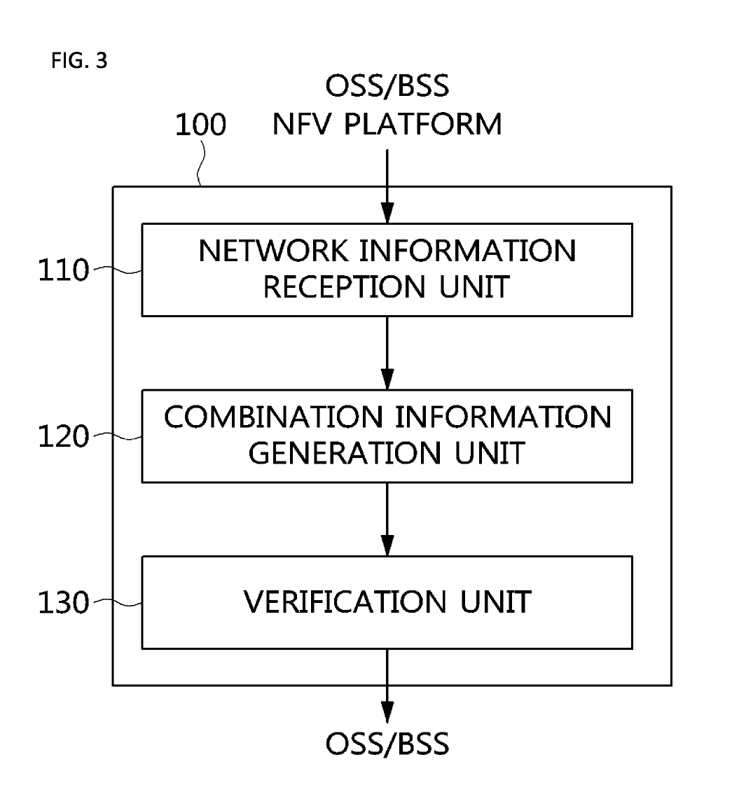

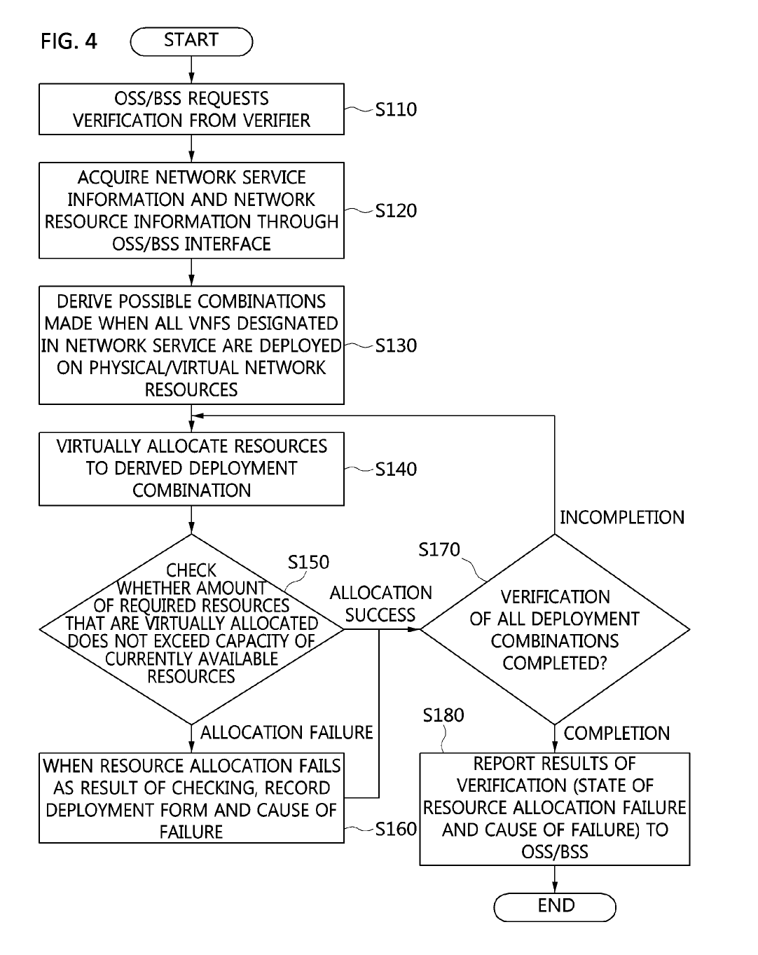

Hereinafter, the NFV resource allocation verifier and a verification method performed by the verifier according to embodiments of the present invention will be described in detail with reference to FIGS. 3 and 4.

The NFV resource allocation verifier 100 according to the present invention includes a network information reception unit 110, a combination information generation unit 120, and a verification unit 130.

In the present embodiment, the network information reception unit 110 receives network service information from Operations Support Systems (OSS) or Business Support Systems (BSS) in an NFV environment. The network service information may be specified in a Network Service Descriptor (NSD).

Further, the network information reception unit 110 additionally receives information about the state of allocation of network resources from the NFV platform 300, which allocates physical or virtual network resources depending on VNFs.

That is, through the interface os-pv in FIG. 2, an NSD and a network service operational policy (NS policy) are received as network service information that is scheduled to be newly registered, and an NFVI policy is received as network resource information.

In the present embodiment, the factors of the network service operational policy (NS policy) may include resource constraints (or deployment flavor), affinity/anti-affinity, scaling, failure/performance management, NS topology, etc.

In the present embodiment, the network resource operational policy (NFVI policy) provides information for load balancing, energy efficiency, etc. to optimally utilize NFVI resources in infrastructure.

More specifically, factors of the NFVI policy include information such as NFVI resource access control, reservation/allocation policies, optimal positioning based on affinity/anti-affinity, geographic/regulatory rules, and the usage or non-usage of resources.

Furthermore, the maximum resources (computing, memory, storage, networking resources, etc.) provided by physical nodes (PNs), information about previously registered NSDs, VNF instances that are currently allocated and are in use, and usage resource information are received as the current network resource state.

Generally, the network service information which is scheduled to be newly registered and the network resource operational policy (NFVI policy), are information managed by the OSS/BSS 200 and are received from the OSS/BSS 200. However, since the current network resource state is information managed by the NFV platform 300, the OSS/BSS 200 may deliver the current network resource state to a verification engine through the NFV platform 300.

Next, in the present embodiment, the combination information generation unit 120 generates combination information made when VNFs 210, required by the network service, are allocated to physical or virtual network resources based on the received network service information.

In the present embodiment, the verification unit 130 verifies whether the combination information is applicable to available network resources in the NFV environment.

Below, a verification process according to the present embodiment will be described with reference to FIG. 4.

Referring to FIG. 4, the verification method performed by the NFV resource allocation verifier 100 according to the present invention premises that the OSS/BSS 200 requests verification from the verifier at step S110.

That is, when the OSS/BSS 200 requests verification, the process for the above-described verification is performed.

In FIG. 2, when verification is requested, the network information reception unit 110 acquires network service information (i.e., NSD and NS policy) and network resource information (i.e., NFVI policy and network resource state) through the OSS/BSS interface at step S120.

Next, the combination information generation unit 120 derives all combinations that are possible when all VNFs designated in the network service are deployed on physical/virtual network resources at step S130, and virtually allocates required resources depending on the form of the derived deployment combinations at step S140.

When resources are virtually allocated in the form of a certain derived deployment combination, the verification unit 130 checks whether the amount of the required resources that are virtually allocated does not exceed the capacity of currently available resources at step S150. If the allocation of resources is found to have failed as the result of the checking, the deployment form and the cause of the failure are recorded at step S160, and the forms of other deployment combinations are additionally verified.

When the verification of all deployment combinations is completed at step S170, the results of verification (the state of the failure in resource allocation and the cause of the failure) are reported to the OSS/BSS at step S180.

In the present embodiment, the VNFs 210 constituting the network service act as a single Virtual Machine (VM) (or one or more VMs), and resource (computing, storage, memory, and networking) requirements are described for each VM. The corresponding VM should be deployed on a single physical resource (physical node: PN), and the location of the deployment should be determined by the NFV platform 300 depending on the resource state and policy. Therefore, since methods for deploying resources cannot be determined in advance, a verification algorithm is configured to arrange and verify all possible cases related to resource deployment methods.

The deployment combinations that are generated according to the above-described present embodiment are shown in the following Table 2 as an example.

TABLE 2

| VNF | NS#1 | | NS#2 | |
|---|---|---|---|---|
| PN | VNF#1 | VNF#2 | VNF#3 | VNF#4 |
| PN1 | 1 | 1 | 0 | 0 |
| PN2 | 0 | 0 | 1 | 0 |
| PN3 | 0 | 0 | 0 | 1 |

In the NFV network of FIG. 2, two network services, that is, NS#1 and NS#2, are installed. Here, NS#1 is composed of VNF#1 and VNF#2, and NS#2 is composed of VNF#3 and VNF#4.

In the environment according to the present embodiment, a VNF is assumed to be implemented as a single VM, and ‘1’ in Table 2 denotes the location of a PN in which the corresponding VNF is deployed. For example, Table 2 shows that VNF#1 is deployed on PN1, VNF#3 is deployed on PN2, and both VNF#1 and VNF#2 are deployed on PN1.

Next, the verification unit 130 determines whether, for the physical resources on which at least one VM is deployed, the total amount of physical resources required by the VM exceeds the maximum capacity of the physical resources, and whether, for respective physical resources on which corresponding VMs are deployed, the physical resources have affinity therebetween (identicalness between the physical resources), thus verifying whether the corresponding deployment combination is applicable.

In the determination of the availability based on the situation of Table 2, as an example of a verification success, it may be determined that VNF#1 and VNF#2 are available if an affinity rule between VNF#1 and VNF#2 is satisfied and the total amount of the resources required by VNF#1 and VNF#2 does not exceed the maximum resource capacity of PN1.

On the other hand, as an example of a verification failure, it may be determined that VNF#3 and VNF#4 are not available because VNF#3 and VNF#4 are deployed on different physical resources PN2 and PN3 and thus violate an affinity rule therebetween. Alternatively, when the amount of the resources required by VNF#3 exceeds the maximum resource capacity of PN2, it may be determined that VNF#3 is not available.

The state of a verification failure attributable to conflicts between policies (policy conflicts) according to the present embodiment will be exemplified with reference to Table 3.

TABLE 3
<Example conflict case #1>
NS policy of NS_A (composed of VNF_A and VNF_B)
Resource constraints: 3 CPU cores for VNF_A and 2 CPU cores for VNF_B
Affinity rule between VNF_A and VNF_B
NFVI policy
No more than 4 CPU cores per physical host
Conflict case
The NS policy cannot be met within the NFVI policy
<Example conflict case #2>
NS policy of NS_B (composed of VNF_A and VNF_B)
Affinity rule between VNF_A and VNF_B
NFVI policy
Place VM whose outbound traffic is larger than 100 Mbps at POP_A
Place VM whose outbound traffic is smaller than 100 Mbps at POP_B
Conflict case
If VNF_A and VNF_B generate traffic of 150 Mbps and 50 Mbps, respectively,
VNF_A and VNF_B need to be placed at POP_A and POP_B, respectively,
according to the NFVI policy
But this will violate the affinity rule given in the NS policy
<Example conflict case #3>
NS policy of NS_C (composed of VNF_A and VNF_B)
Resource constraints: VNF_A and VNF_B exist in the same POP
Auto-scaling policy: if VNF_A has more than 300K CPS, scale-out
NFVI policy
No more than 10 VMs per physical host in POP_A
Conflict case
If CPS of VNF_A in POP_A gets more than 300K CPS,
and if there is no such physical host in the POP_A whose VMs are fewer than 10,
VNF_A needs to be scaled out to a POP other than POP_A according to the NFVI
policy
But this will violate the NS policy

Hereinafter, attributes used for verification in the present invention will be described in detail.

The process for verifying network resource allocation according to the present embodiment classifies the results of verification as a verification failure when the amount of the resource requirements of VNFs for each resource deployment combination exceeds the maximum resource capacity of a PN, and records the cause of the failure. In this case, attributes to be verified include 1) VM resources such as computing, storage, memory, and networking resources, which are expressed quantitatively, and 2) VM attributes, which are not expressed quantitatively (e.g. an affinity rule), wherein detailed verification attributes are given in the following Table 4.

```
TABLE 4
NS resource requirements
  Virtualization Deployment Unit (VDU) resource requirements: CPU, memory,
storage, network (outbound bandwidth), etc.
    According to NFV specification, resource requirements are defined in
nsd:service_deployment_flavor:constituent_vnf:vdu structure
      computation_requirement
      virtual_memory_resource_element
      virtual_network_bandwidth_resource
      virtual_storage_requirement
  Affinity rule
    According to NFV specification, resource requirements are defined in
nsd:service_deployment_flavor:constituent_vnf:affinity structure
  Resource requirements recorded in NSD, such as auto-scaling policy
NS Policy
  Operational policy for resources used by VNFs constituting network service
(although resource operation methods such as affinity rule and auto-scaling policy are
described in NSD, they are regarded as resource requirements directly recorded in the
descriptor, and the NS policy indicates a resource operational policy not recorded in
NSD)
  e.g.: Anti-affinity rule of active-standby VMs
NFVI policy
  Operational policies for all resources in network infrastructure (NFVI) (these
influence all network services)
  e.g.: Geo-location, energy efficiency, load balancing
```

In accordance with the present invention, a network service provider and a network administrator may detect problems related to resource availability in advance, thus more securely deriving the design of network services and the planning to secure network resources. The network service provider may adjust resource requirements and operational policies complying with the expected performance of network services by predicting the state of resource allocation before an actual service is initiated. A network operator may estimate the total network capacity that is required in order to simultaneously execute multiple established network services, and the efficiency of the network services.

Further, such a verification structure may be operated without changing existing NFV interfaces or structures, and may perform verification before the network services are installed and executed, thus avoiding errors that may occur in the network service currently being provided.

Furthermore, in accordance with the configuration algorithm and attributes of the present invention, all cases for resource deployment combination may be arranged and used to verify the availability of resources, and thereby the possibility of problems occurring may be checked regardless of the sequence of execution of network services. Furthermore, an NS policy and an NFVI policy, which are not defined in an NSD, may also be verified. Additionally, resource requirements or resource operational policies, which are not expressed quantitatively, may also be verified.

As described above, the present invention is advantageous in that a network service provider and a network administrator may detect problems related to resource availability in advance, thus more securely deriving the design of network services and the planning to secure network resources. The network service provider may adjust resource requirements and operational policies complying with the expected performance of network services by predicting the state of resource allocation before an actual service is initiated. A network operator may estimate the total network capacity that is required in order to simultaneously execute multiple established network services, and the efficiency of the network services.

Further, the present invention is advantageous in that all cases for resource deployment combination may be arranged and used to verify the availability of resources, and thereby the possibility of problems occurring may be checked regardless of the sequence of execution of network services. Furthermore, an NS policy and an NFVI policy, which are not defined in an NSD, may also be verified. Additionally, resource requirements or resource operational policies, which are not expressed quantitatively, may also be verified.

Although the above description has been made to describe the technical spirit of the present invention for illustrative purposes, those skilled in the art will appreciate that various modifications, additions and substitutions are possible, without departing from the essential features of the present invention.

Therefore, the embodiments disclosed in the present invention and the attached drawings are not intended to limit the technical spirit of the present invention, but are merely intended to describe the present invention, and the scope of the technical spirit of the present invention is not limited by the embodiments and the drawings. The scope of the present invention should be defined by the accompanying claims, and all of the technical spirit of the claims and equivalents thereof should be construed as being included in the scope of the present invention.

What is claimed is:

1. A verifier for Network Function Virtualization (NFV) resource allocation, comprising:
a network information reception unit for receiving information about network services from Operations Support Systems (OSS) or Business Support Systems (BSS) in an NFV environment;
a combination information generation unit for generating combination information made when Virtualized Network Functions (VNFs) required by each network service are allocated to physical or virtual network resources, based on the received network service information; and
a verification unit for verifying whether the combination information is applicable to available network resources in the NFV environment.

2. The verifier of claim 1, wherein:
the network information reception unit further receives Network service policy (NS policy), network service descriptor (NSD) and NFV Infrastructure policy (NFVI policy) from the OSS or the BSS, and information about an allocation state of the network resources from an NFV platform, which allocates physical or virtual network resources depending on VNFs, and
the verification unit verifies whether the combination information is applicable using the NS policy, NSD and NFVI policy and the allocation state information .

3. The verifier of claim 2, wherein the combination information generation unit is configured to generate virtual combination information on a condition that the VNFs are operated in at least one Virtual Machine (VM), and the VM is deployed on physical resources determined by the NFV platform depending either on whether physical network resources are allocated or on an network resource operational policy.

4. The verifier of claim 3, wherein the network service information includes:
information about resource requirements of each network service;
information about an operational policy of resources used by VNFs constituting the network service; and
information about an operational policy of resources in the NFV environment.

5. The verifier of claim 4, wherein the information about resource requirements includes quantifiable information about a Central Processing Unit (CPU), memory, and networking performance and information about an affinity between VMs in which VNFs are operated.

6. The verifier of claim 3, wherein the verification unit determines whether, for physical resources on which at least one VM is deployed, a total amount of the physical resources required by the VM exceeds a maximum capacity of the physical resources, thus verifying whether the combination information is applicable.

7. The verifier of claim 3, wherein the verification unit determines whether, for respective physical resources on which corresponding VMs are deployed, the physical resources have an affinity therebetween, thus verifying whether the combination information is applicable.
